(19) United States
(12) Patent Application Publication
(10) Pub. No.: US 2025/0379827 A1
(43) Pub. Date: Dec. 11, 2025

(54) FLOW SCHEDULING IN MULTI-STAGE INTERCONNECTION NETWORKS

(71) Applicant: Clockwork Systems, Inc., Palo Alto, CA (US)

(72) Inventors: Vinay Kotikalapudi Sriram, Mountain View, CA (US); Yilong Geng, Menlo Park, CA (US); Akram O Sbaih, Mountain View, CA (US); Jinkun Geng, Stanford, CA (US); Balaji S. Prabhakar, Palo Alto, CA (US)

(21) Appl. No.: 19/288,604

(22) Filed: Aug. 1, 2025

Related U.S. Application Data
(63) Continuation of application No. 19/046,027, filed on Feb. 5, 2025.
(60) Provisional application No. 63/550,845, filed on Feb. 7, 2024.
(60) Provisional application No. 63/667,335, filed on Jul. 3, 2024.

(51) Int. Cl. H04L 47/283; H04L 47/11; H04L 47/30

(52) U.S. Cl. CPC H04L 47/283; H04L 47/11; H04L 47/30

(57) ABSTRACT

For each respective flow over a network initiated by an application layer, a controller determines a respective path taken by the respective flow from respective source host to respective destination host, transmits respective probe packets along the respective path while taking timestamps at the respective source host and the respective destination host, and determines a respective one-way delay for the respective path based on the timestamps. The controller determines utilization for each path, determines determining an optimal usage across each path, and schedules transmission of data for each respective flow based on the optimal usage.

### CROSS-REFERENCE TO RELATED APPLICATION(S)

The present application is a continuation application of U.S. Pat. No. 19/046,027, filed Feb. 5, 2025, which claims the benefit of U.S. Provisional Patent Application No. 63/667,335, filed on Jul. 3, 2024 and U.S. Provisional Patent Application No. 63/550,845, filed on Feb. 7, 2024, which are hereby incorporated by reference in its entirety.

### TECHNICAL FIELD

This disclosure relates generally to network transmissions and coordinated control of network traffic at the application layer.

### BACKGROUND

Existing control systems operate at the control layer to control packet transmissions on a network. While this is often sufficient to operate network controls, there are times that a network controller does not have access to a required control point. For example, a third-party system may be unable to access a network interface card (NIC) of a host machine, where instructions travel directly from memory to the NIC with no intermediate point for intervention by the controller. In these scenarios where NICs or other network components are closed environments, a controller is unable to perform network traffic controls and improve traffic flow conditions.

Moreover, limits to clock synchronization accuracy between machines (e.g., in a data center) impose practical limitations in many applications. For example, in finance and e-commerce, clock synchronization is crucial for determining transaction order, in that a trading platform must match bids and offers in the order in which those bids and offers are placed. If clocks of machines used to submit or route the bids and offers are not synchronized, then bids and offers may be matched out of order, which results in a lack of fairness. Similar problems occur in other networked computer systems, such as distributed databases, distributed ledgers (e.g., blockchain), distributed transaction tracing systems, distributed snapshotting of computation or networks, 5G mobile network communications, and so on. In these systems, limits on clock synchronization result in jitter, which results in biased or non-optimal processing of communications.

Clock synchronization limitations have become more prominent in multi-stage interconnection networks requiring flow scheduling for high-intensity applications such as training and using large language models. In some cases, accessing timestamps at hops (e.g., switches) between source and destination to perform OWD calculations is not possible where switches are not individually accessible. Therefore, existing systems rely on in-network support from switches, resulting in actions taken without central knowledge. Moreover, RDMA (Remote Direct Memory Access) networks may not allow for accessing such interim switches, thereby limiting the ability to perform synchronization and coordinated control in such scenarios.

### SUMMARY

Systems and methods are disclosed herein for edge-based scheduling of flows that does not require in-network support (e.g. non-standard measurements collected by the network switches). In some embodiments, paths and link quality are detected using a probe mesh. The system detects utilization across each detected path, and performs scheduling of data traffic across each path. The systems and methods disclosed herein allow for a central fabric scheduler to operate in environments that are typically closed, such as Infiniband, RoCE, and the like. These environments are increasingly used by large language models (LLMs) for training and inference operations.

Systems and methods are disclosed herein to control messages at the application layer, rather than (or in addition to) the control layer. These systems and methods enable a controller to act on an application message to perform coordinated control even where the underlying packets that form the message are within a closed environment and cannot be directly coordinated. Various kernel-bypass transport mechanisms enable latency to be reduced when packets traverse the OSI network stack to allow for feasibility of an application-layer implementation where only control layer implementations were previously possible.

In some embodiments, a controller detects that an application is initiating transmission of a message from a sender host to a receiver host. The controller records one or more application layer sender timestamps corresponding to the transmission of the message, and records one or more application layer receiver timestamps based on detecting receipt of at least a portion of the message at the receiver host. Responsive to detecting that the message has been completely received by the receiver host, the controller determines a message duration spanning a length of time between a first one of the application layer sender timestamps and a last one of the application layer receiver timestamps. The controller performs a network traffic control function based on the message duration.

### BRIEF DESCRIPTION OF THE DRAWINGS

FIG. 1 is an exemplary system environment for implementing netcam and priority functions, according to an embodiment of the disclosure.

FIG. 2 is a network traffic diagram showing multiple sender hosts sending multiple data flows to a single receiver host, according to an embodiment of the disclosure.

FIG. 3 is a network traffic diagram showing a timestamping operation at both a sender and receiver side of a data transmission, according to an embodiment of the disclosure.

FIG. 4 is a data flow diagram showing netcam activities during normal operation and where an anomaly is detected, according to an embodiment of the disclosure.

FIG. 5 is a network traffic diagram showing a receiver host receiving both high and low priority traffic from sender hosts, according to an embodiment of the disclosure.

FIG. 6 is a data flow diagram showing netcam activities where priorities are accounted for in determining netcam activity, according to an embodiment of the disclosure.

FIG. 7 is a data flow diagram showing netcam activities where shadow buffer considerations are depicted, according to an embodiment of the disclosure.

FIG. 8 illustrates exemplary sub-modules of a netcam module for use in a long-link environment, in accordance with an embodiment of the disclosure.

FIG. 9 illustrates a graphical depiction of an application for applying quantized pauses, in accordance with an embodiment of the disclosure.

FIG. 10 illustrates a network traffic diagram showing a message rocket implementation for applying network control to application layer messages, in accordance with an embodiment.

FIG. 11 illustrates an exemplary flowchart for applying network control to application layer messages, in accordance with an embodiment.

FIG. 12 is a network diagram for an exemplary multi-stage interconnection network, in accordance with an embodiment.

FIG. 13 shows exemplary shadow queue pairs instructed to follow paths of their corresponding application queue pairs.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Systems and methods are disclosed herein for coordinating control of data flows in the face of transient congestion.

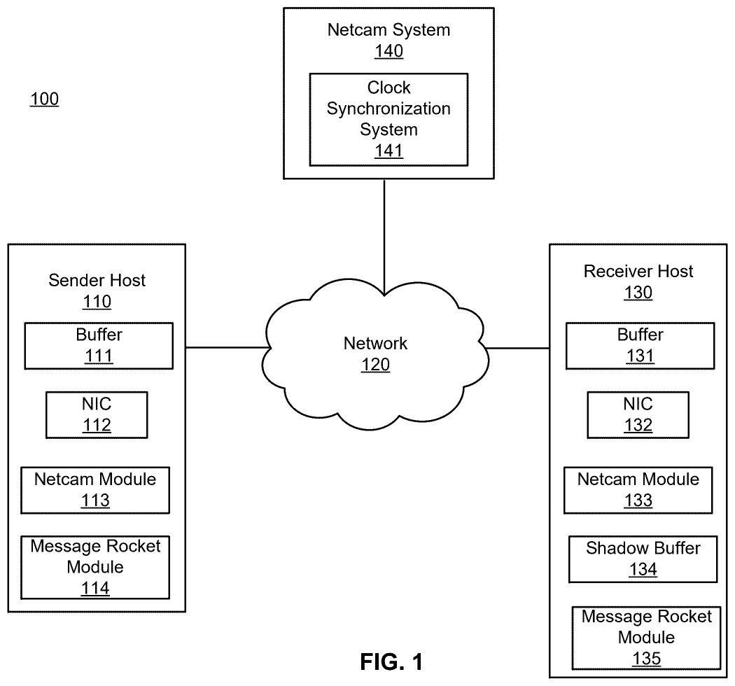

FIG. 1 is an exemplary system environment for implementing netcam and priority functions, according to an embodiment of the disclosure. As depicted in FIG. 1, netcam environment 100 includes sender host 110, network 120, receiver host 130, and clock synchronization system 140. While only one of each of sender host 110 and receiver host 130 is depicted, this is merely for convenience and ease of depiction, and any number of sender hosts and receiver hosts may be part of netcam environment 100.

Sender host 110 includes buffer 111, Network Interface Card (NIC) 112, netcam module 113, and message rocket module 114. Buffer 111 stores a copy of outbound data transmissions until one or more criteria for overwriting or discarding packets from the buffer is met. For example, the buffer may store data packets until it is at capacity, at which time the oldest buffered data packet may be discarded or overwritten. Other criteria may include a time lapse (e.g., discard packets after predetermined amount of time has elapsed from its transmission timestamp), an amount of packets buffered (e.g., after a predetermined amount of packets are buffered, begin to discard or overwrite oldest packet as new packets are transmitted), and the like.

In an embodiment, buffer 111 stores information relating to given outbound transmissions, rather than entire packets. For example, a byte stamp may be stored rather than the packet itself, the byte stamp indicating an identifier of the packet and/or flow identifier and a time stamp at which the packet (or aggregate data flow) was sent. In such an embodiment, the stored information need not be overwritten, and may be stored to persistent memory of sender host 110 and/or clock synchronization system 140. This embodiment is not mutually exclusive to buffer 111 storing copies of packets, and they may be employed in combination.

NIC 112 may be any kind of network interface card, such as a smart NIC. NIC 112 interfaces sender host 110 and network 120.

Netcam module 113 monitors data flow for certain conditions, and triggers functionality based on the monitored data. As an example, netcam module 113 may, responsive to detecting network congestion, instruct all hosts that are part of a data flow to perform one or more of various activities, such as pausing transmissions, taking a snapshot of buffered data transmissions (that is, writing buffered data packets to persistent memory), and performing other coordinated activity.

A “netcam” monitors network traffic between clock-synchronized sender and receiver hosts that are part of a data flow. The term “netcam” as used herein, is a term that is short for “network camera,” and is a module that tracks network traffic and ensures remedial action is taken where traffic of a data flow in clock-synchronized systems lags beyond tolerable limits. The netcam instructs sender and receiver hosts to buffer copies of network traffic according to some parameter (e.g., buffer a certain number of packets, buffer packets for a rolling window of time, etc.). Buffers may be overwritten on a rolling basis where the parameter is achieved (e.g., overwrite oldest packet when new packet is transmitted or received and when buffer is full). The netcam may have all sender and receiver hosts write buffer data where an anomaly is detected, and may have the sender hosts re-transmit the written packets. The re-transmission may be subject to jitter (e.g., a time delay between packet transmissions of the data flow), such that where transmission delay or failure occurred due to a given sequence of packet transmission, the jitter causes enough change to nonetheless have the re-transmission attempt succeed. The netcam may determine a need to write and re-transmit packets differently depending on a priority of a data flow. The netcam may instruct shadow buffers at receiver hosts to monitor path usage and capacity, where high usage and/or low capacity may cause the netcam to predict an upcoming anomaly and take remedial action similar to that taken where a buffer is full.

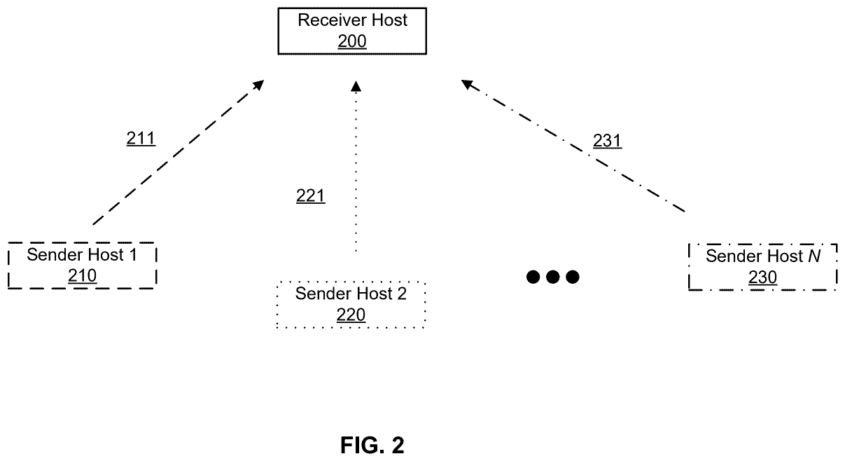

As used herein, the term data flow may refer to a collection of data transmissions between two or more hosts that are associated with one another. Further details of netcam module 113 are described in further detail with respect to FIGS. 2-8 below. Netcam module 113 may be implemented in any component of sender host 110. In an embodiment, netcam module 113 may be implemented within NIC 112. In another embodiment, netcam module 113 may be implemented within a kernel of sender host 110.

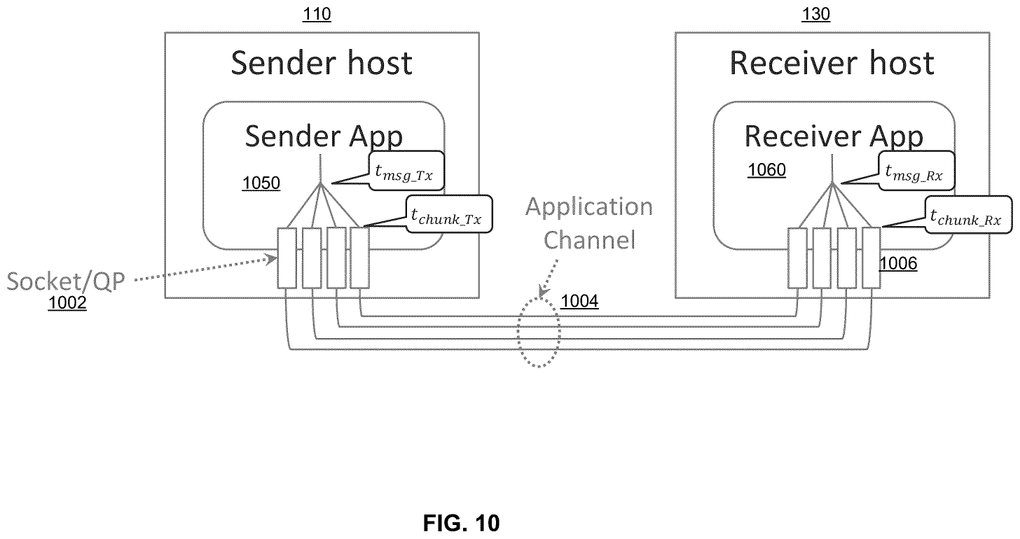

Message rocket module 114 acts similarly to netcam module 113, but operates at the application layer. That is, message rocket module 114 monitors one-way delay of application messages (rather than lower level messages, as is monitored by netcam), and enforces pause functions depending on metrics monitored at that level. This enables monitoring regardless of underlying network stack (e.g., TCP/UDP/Infiniband/ROCE are all compatible with message rocket module 114, as is any other protocol). Further details relating to message rocket module 114 functionality are described below with respect to FIGS. 10+.

Network 120 may be any network, such as a wide area network, a local area network, the Internet, or any other conduit of data transmission between sender host 110 and receiver host 130. In some embodiments, network 120 may be within a data center housing both sender host 110 and receiver host 130. In other embodiments, network 120 may facilitate cross-data center transmissions over any distance. The mention of data centers is merely exemplary, and sender host 110 and receiver host 130 may be implemented in any medium including those that are not data centers.

Receiver host 130 includes netcam buffer 131, NIC 132, netcam module 133, shadow buffer 134, and message rocket module 135. Netcam buffer 131, NIC 132, netcam module 133, and message rocket module 135 operate in similar manners to the analog components described above with respect to sender host 110. Buffer 131 may be a same size or a different size from buffer 111, and may additionally or alternatively store byte stamps for received packets. Any further distinctions between these components as implemented in sender versus receiver host will be apparent based on the disclosure of FIGS. 2-9 below.

Shadow buffer 134 may be used for tracking data traffic in a manner that enables an early warning of when congestion is likely to come. For example, as data traffic is buffered, congestion may occur when the buffer is full, the congestion preventing further data traffic from flowing until the congestion is cleared. A shadow buffer may increment a counter more quickly than regular buffer (e.g., increment by 1.1 where 1 unit of data is received at a regular buffer), and/or may decrement the counter more slowly than a regular buffer (e.g., decrement by 0.9 or 0.95 where 1 unit of data is cleared at the regular buffer). The term regular buffer, as used herein, may refer to activity of buffers 111 and/or buffer 131 and/or other buffers disclosed herein having similar functionality to that of buffers 111 and/or 131. While only one shadow buffer 134 is depicted in FIG. 1, multiple shadow buffers may be employed at receiver hosts, and each shadow buffer may be allocated to a different subset of data flows, such as data flows each corresponding to a same application. The shadow buffers may increment/decrement at different rates (e.g., to show more congestion for lower priority applications, and to show less congestion for higher priority applications). Alternatively, the shadow buffers may increment/decrement at same rates, but different thresholding may be applied for different applications as to when a data flow should be considered to be facing congestion. Data buffered in a regular buffer includes data traffic (e.g., network packets) received by a receiver; the data is removed from the regular buffer as the data is processed and/or routed to a next destination. Activity described herein of netcam module 113 and/or netcam system 140 taking action with respect to conditions being met with respect to regular buffers may equally be performed where shadow buffer 134 indicates congestion.

Netcam system 140 includes clock synchronization system 141. Netcam system 140 may monitor data observed by the netcam modules implemented in hosts, such as netcam module 131 and 133. Netcam system 140 may detect conditions that require action by the netcam modules and may transmit instructions to affected netcam modules to take coordinated action for a given data flow. Clock synchronization system 141 synchronizes one or more components of each host, such as the NIC, the kernel, or any other component within which the netcam modules act. Details of clock-synchronization are described in commonly-owned U.S. Pat. No. 10,623,173, issued Apr. 14, 2020, the disclosure of which is hereby incorporated by reference herein in its entirety. Each host is synchronized to an extremely precise degree to a same reference clock, enabling precise timestamping across hosts regardless of host location, bandwidth conditions of the host, jitter, and the like. Further details of netcam system 140 are disclosed below with reference to FIGS. 2-8. Netcam system 140 is an optional component of netcam environment 100, and the netcam modules of the sender and/or receiver hosts can operate netcam modules without reliance on a centralized system, other than reliance on a reference clock with which to synchronize.

There are many advantages of netcam environment 100. The netcam modules are edge-based, given that they can run in the kernel or in NICs (e.g., smart NICs) of a host (e.g., physical host, virtual machine, or any other form of host). In an embodiment, the netcam functionality may run as an underlay, meaning that it may run, e.g., as a shim, on a layer of the OSI system under a congestion control layer (e.g., layer 3 of the OSI system). The netcam modules and/or netcam system 140 may instruct hosts to perform activity upon detection of a condition (e.g., a congestion signal is detected using a shadow buffer), such as pausing transmission of a data flow across affected hosts, taking a snapshot (that is, writing some or all of the buffered data, such as the last N bytes transmitted and/or the bytes transmitted in the last S seconds, where N or S may be default values or defined by an administrator), and any other activity disclosed herein. Further advantages and functionality are described below with respect to FIGS. 2-8.

FIG. 2 is a network traffic diagram showing multiple sender hosts sending multiple data flows to a single receiver host, according to an embodiment of the disclosure. As depicted in FIG. 2, sender host 1 is sending data flow 211 to receiver host 200, sender host 220 is sending data flow 221 to receiver host 200, and, represented by sender host 230, any number of additional hosts may be transmitting respective data flows (represented by data flow 231) to receiver host 200. As depicted in FIG. 2, each data flow sent by each sender host is different; however, this is merely for convenience two or more sender hosts may transmit data from the same data flow. Moreover, a single sender host may send two or more different data flows to receiver host 200. While only one receiver host is depicted, sender hosts may transmit data flows to any number of receiver hosts.

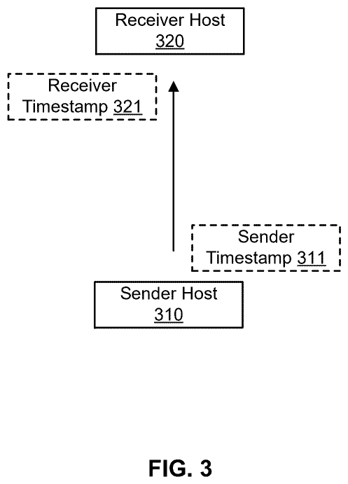

We turn for the moment to FIG. 3 to discuss operation of netcam modules at sender and receiver hosts. FIG. 3 is a network traffic diagram showing a timestamping operation at both a sender and receiver side of a data transmission, according to an embodiment of the disclosure. As depicted in FIG. 3, when sender host 310 transmits a packet to receiver host 320, netcam module 113 of receiver host 320 records sender timestamp 311. Similarly, when receiver host 320 receives the packet, netcam module 133 of receiver host 320 applies receiver timestamp 321. The timestamp reflects a time at which the data packet was sent or received by the relevant component on which the netcam module is installed (e.g., NIC, kernel, etc.). Sender timestamps may be stored in buffers 111 and 131, appended to packets, transmitted for storage in netcam system 140, or any combination thereof.

Because sender host 310 is synchronized to a same reference clock as receiver host 320, the elapsed time between the time of sender timestamp 311 and receiver timestamp 321 reflects a one-way delay for a given packet. In an embodiment, upon receiving a given packet, receiver host 320 transmits an acknowledgment packet to sender host 310 that indicates receiver timestamp 321, by which netcam module 113 can calculate the one-way delay by subtracting the sender timestamp 311 from the receiver timestamp 321. Other means of calculating the one-way delay are within the scope of this disclosure. For example, the sender timestamp 311 may be appended to the data transmission, and receiver host 320 may thereby calculate the one-way delay without a need for an acknowledgment packet. As yet another example, the netcam modules of sender hosts and receiver hosts may transmit, either in batches or individually, timestamps to netcam system 140, which may calculate one-way delay therefrom. For the sake of convenience and brevity, the scenario where sender host 110 calculates one-way delay based on an acknowledgment packet will be the focus of the following disclosure, though one of ordinary skill in the art would recognize that any of these means of calculation equally apply.

In an embodiment, the netcam system then determines whether the one-way delay exceeds a threshold. For example, after calculating one-way delay, sender host 110 may compare the one-way delay to the threshold. The threshold may be predetermined or dynamically determined. Predetermined thresholds may be set by default or may be set by an administrator. As will be described further below, different thresholds may apply to different data flows depending on one or more attributes of the data flows, such as their priority. The threshold may be dynamically determined depending any number of factors, such as dynamically increasing the threshold as congestion lowers, and decreasing the threshold as congestion rises (e.g., because delay is more likely to be indicative of a problem where congestion is not a cause or is a minor cause). In one embodiment, thresholds may be set on a per-host basis, as they may depend on a distance between a sender host and a receiver host. In such an embodiment, the threshold may be a predefined multiple of a minimum one way delay between a sender and a receiver host. That is, the minimum amount of time by which a packet would need to travel from a sender host to a receiver host would be a minimum one-way delay. The multiple is typically 1.5×-3× the minimum, but may be any multiplier defined by an administrator of the netcam. The threshold is equal to the multiple times the minimum one-way delay. Responsive to determining that the one-way delay exceeds the threshold, netcam module 113 may instruct sender host 110 to take one or more actions.

In an additional or alternative embodiment, determining whether to take one or more actions may be performed using a separate measure of a status of a shadow buffer (e.g., shadow buffer 134). In short (further detail will be described below), during a given data flow, and in parallel with buffering data using a regular buffer, netcam module 133 may instruct shadow buffer 134 be incremented for each unit of data traffic received by receiver host 320. Netcam module 133 may define a dynamic drain rate, which is a rate at which netcam module 133 instructs shadow buffer 134 be decremented. The dynamic drain rate may be determined by netcam module 133 based on a number of units of data removed from buffer 131 per unit of time (e.g., multiplied by a factor that causes drain to occur more slowly in shadow buffer 134 than it occurs in buffer 131). Netcam module 133 may calculate a dwell time as a function of the counter of shadow buffer 134 and the dynamic drain rate (e.g., the dwell time may be calculated by a value of the counter of the shadow buffer divided by the dynamic drain rate). From here, netcam module 133 may determine a one-way delay of the shadow buffer to be the actual one-way delay (determined from the sender and receiver timestamps, described above) as aggregated with the dwell time. The one-way delay of the shadow buffer may be used for comparison against the threshold (in addition to, or instead of, the one-way delay of the regular buffer) to determine whether to take one or more actions.

Whether driven by the regular buffer or the shadow buffer one-way delay, these one or more actions may include pausing transmission from that sender host when one-way delay is high, which reduces congestion and thereby reduces packet drops on network 120 in general. The pause may be for a predetermined amount of time, or may be dynamically determined proportionally to the magnitude of the one-way delay. In an embodiment, the pause may be equal to the one-way delay or may be determined by applying an administrator-defined multiplier to the one-way delay. In an embodiment, the netcam determines whether a prior pause is being enforced, and if so, may reduce the pause time based on a prior amount of pause time that has already elapsed from previously acknowledged packets. Moreover, a given data flow may not be the only data flow contributing to congestion, and thus its pause duration may be smaller than the one-way delay or the one-way delay threshold.

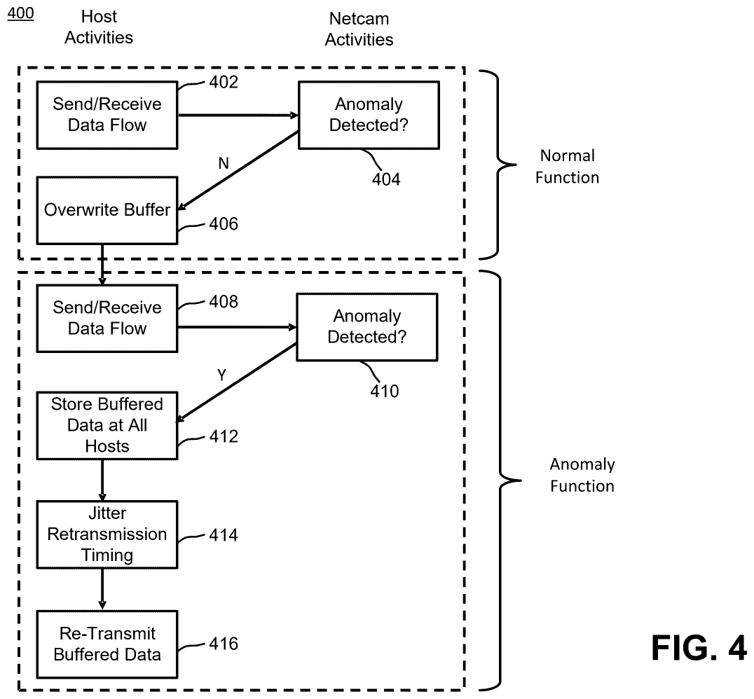

Another action that may be taken is to write some or all buffered data packets (e.g., from either or both of the sender host and receiver host) to persistent memory responsive to the one-way delay exceeding the threshold. Diagnosis may then be performed on the buffered data packets (e.g., to identify network problems). Further actions are described with respect to FIGS. 4-8 in further detail below.

In some embodiments, data flows may be associated with different priorities. Netcam modules may determine priority of data flows either based on an explicit identifier (e.g., an identifier of a tier of traffic within a data packet header), or based on inference (e.g., based on heuristics where rules are applied to packet header and/or payload to determine priority type). Priority, as used herein, refers to a precedence scheme for which types of data packets should be allowed to be transmitted, and which should be paused, during times of congestion. The priorities disclosed herein avoid a need for underutilizing a link or making explicit allocations of bandwidth, and instead are considered in the context of choosing what packets to transmit during network congestion.

In order to prioritize high priority packets, a high one-way threshold may be assigned to high priority traffic, and a low, relative to the high one-way threshold, may be assigned to the low priority traffic. These thresholds may be used for comparison against either, or both of, a shadow buffer one-way delay and/or a regular buffer one-way delay. In this manner, low priority packets will have anomalies detected more frequently than high priority packets, because a lower one-way delay is required to be detected for a low priority packet for an anomaly to be detected by a netcam module, whereas high priority packets will have anomalies detected only when a higher one-way delay threshold has been breached. Following from the above discussion of determining the one-way threshold for a given host, different one-way thresholds may be applied to different data packets that are sent by or received by a same host depending on priority. In priority embodiments, the one-way threshold may be determined in the manner described above (e.g., by applying a predetermined multiplier to the threshold), where the determination is additionally influenced by applying a priority multiplier. The priority multiplier may be set by an administrator for any given type of priority, but will be higher for higher priorities, and lower for lower priorities. Priority need not be binary—any number of priority tiers may be established, each corresponding to a different type or types of data traffic, and each having a different multiplier. Priorities and their associated multipliers may change over time for given data flows (e.g., where a data flow begins transmitting a different type of data packet that does not require high latency transmission, priority may be reduced).

Additionally or alternatively to using a priority multiplier on one-way delay thresholds and differentiating one-way delay thresholds based on priority of a given packet or data flow within which a packet is transmitted, the netcam modules may manipulate the pause time of paused traffic during a pause operation differently depending on priority. A low pause time may be assigned to higher priority traffic, and a relatively high pause time may be assigned to lower priority traffic, ensuring that lower priority traffic is paused more often than high priority traffic during times of congestion, and thereby ensuring that higher priority traffic has more bandwidth available while the lower priority traffic is paused. The pause times may be determined in the same manner as described above, but with the additional step of applying an additional pause multiplier to the pause times, with lower pause multipliers (e.g., multipliers that are less than 1, such as 0.7×) for high priority traffic, and higher pause multipliers (e.g., multipliers that are more than 1) for lower priority traffic.

Priority may be allocated in any number of ways. In an embodiment, one or more “carpool lanes” may be allocated that can be used by data flows having qualifying priorities. For example, a “carpool lane” may be a bandwidth allocation that does not guarantee a minimum bandwidth for a given data communication, but that can only be accessed by data flows satisfying requisite parameters. Exemplary parameters may include one or more priorities that qualify to use the reserved bandwidth of a given “carpool lane.” As an example, a carpool lane may require that a data flow has at least a medium priority, and thus both medium and high priorities qualify in a 3-priority system having low, medium, and high priorities. As another example, multiple carpool lanes may exist (e.g., a carpool lane that can only be accessed by high priority traffic in addition to a carpool lane that can be accessed by both medium and high priority traffic).

In an embodiment, guaranteed bandwidth may be allocated to a given priority. For example, a high priority data flow may be allocated a minimum bandwidth, such as 70 mbps. In such an embodiment, excess unused bandwidth from what is guaranteed may be allocated to lower priority data flows until such a time that the bandwidth is demanded by a data flow that qualifies for the guarantee. Guaranteed bandwidth may be absolute or relative. Relative guarantees guarantee that a given priority data flow will receive at least a certain relative amount more bandwidth than a low priority data flow. For example, a high priority data flow may be guaranteed 3× the bandwidth of a low priority data flow, and a medium priority data flow may be guaranteed 2× the bandwidth of a low priority data flow.

Returning to FIG. 2, where two or more sender hosts transmit data from a same data flow, those nodes, in tandem, and in addition to any receiver hosts that are receiving the data from the data flow, may be referred to as a “cluster.” In an embodiment, a data flow may be identified by a collection of identifiers that, if all detected, represent that a data packet is part of a data flow. For example, a netcam module of any host may determine a flow identifier that identifies a data flow to which a packet belongs based on a combination of source address, destination address, source port number, destination port number, and protocol port number. Other combinations of identifiers may be used to identify a data flow to which a packet is a part. As stated before, the hosts of the cluster are all clock-synchronized against a same reference clock, no matter their form (e.g., server, virtual machine, smart NIC, etc.).

In a scenario where data flows 211 and 221 are a same data flow, sender host 210, sender host 220, and receiver host 200 form a cluster. Following this example, buffering of data packets (across both regular buffers and shadow buffers) may occur on a per-flow level across a cluster of hosts. That is, one or more netcam modules and/or netcam system 140 may record within buffers of hosts of a data flow all packets transmitted or received within whatever parameter the buffer uses to record and then overwrite data (e.g., most recently transmitted packets, packets transmitted/received within a given amount of time, etc.). Moreover, a receiver node receiving packets of a data flow from multiple sender hosts (e.g., receiver host 200 receiving packets from sender hosts 210 and 220) may maintain a single shadow buffer for the data flow, or may maintain separate shadow buffers, one for each of sender host 210 and sender host 220. In an embodiment, indicia of a timed sequence, relative to the reference clock, is stored with the buffered data (e.g., sender timestamp 311 and/or receiver timestamp 321 is stored with a buffered data packet). Thus, sender host 210 and sender host 220 may store in their buffers 111 data packets that share a given flow ID, and receiver host 200 may store received packets within buffer 131. Alternatively or additionally, transmitted and/or received packets may be transmitted to netcam system 140, which may buffer received data.

From this vantage point of buffering a certain amount of data at each host of a cluster, different functionality of host netcam modules is possible responsive to detection of an anomaly (e.g., the aforementioned conditions mentioned with respect to FIG. 2 above). FIG. 4 is a data flow diagram showing netcam activities during normal operation and where an anomaly is detected, according to an embodiment of the disclosure. Data flow 400 reflects host activities and netcam activities (e.g., activities taken by netcam modules of sender/receiver hosts or netcam system 140) during normal function, and during an “anomaly function” (that is, action taken where an anomaly is detected). Data flow 400 first shows normal function, where hosts send or receive 402 data flows, and the netcam module or system (referred to generally in this figure as “netcam”) determines 404 whether an anomaly is detected (e.g., based on one-way delay, as discussed above). Where no anomaly is detected, on the assumption that the buffer is full from prior storage of data packets, the host(s) (e.g., of a cluster) overwrite 406 their buffer(s) (e.g., meaning overwrite oldest packet or follow some other overwrite heuristic as described above). Of course, where buffers are not full, overwriting is not necessary, and storing to a free memory of the buffer occurs. Normal function repeats unless an anomaly is detected.

Anomaly function occurs where an anomaly is detected. Different anomaly functions are disclosed herein, and data flow 400 focuses on illustrating a particular anomaly function of re-transmitting buffered data. Where sending/receiving 408 information of a data flow by hosts (e.g., of a cluster), the netcam may detect 410 an anomaly. As mentioned above, anomalies are detected where one-way delay (e.g., of a shadow buffer and/or of a regular buffer) exceeds a threshold. Recall that for a cluster, the threshold may vary between hosts of the cluster depending on distance between sender and receiver hosts. Responsive to detecting the anomaly, the netcam instructs 412 the buffered data to be stored at all hosts of the cluster. That is, where an anomaly occurs on even one host of a cluster, data from all nodes of the cluster is stored. This may occur by instructing the hosts to store the buffered data (or the portion thereof relating to the data flow) to persistent memory, or by keeping the buffered data within the buffer and pausing data transmissions, or a combination thereof with different instructions for different hosts. Note that where pause is used, pause time may vary across the different nodes of the cluster, as mentioned above. Regardless of how the data is stored, the netcam may jitter 414 retransmission timing. Recall that the timed sequence of packet transmissions and receptions is reflected in the stored data packets. The netcam may jitter 414 the retransmission timing by altering the timed sequence (e.g., creating longer lag between a previous time gap between transmissions, transmitting the packets in a different order, etc.). The jitter may occur according to a heuristic, or may be random. Jitter is applied in case the prior attempted timed sequence was the cause of the failure (e.g., because the prior attempted timed sequence itself may cause too much transient congestion), and thus the jitter may in such a scenario result in a success where re-transmission without jitter would fail. The netcam then re-transmits 416 the buffered data (or portion thereof). Note that it may be more expedient and computationally efficient to re-transmit the entire buffer, including data unrelated to the data flow or the anomaly, rather than isolating the packets of the data flow that relate to the anomaly. Normal function then resumes until another anomaly is detected.

Re-transmission with jitter is only one example of anomaly function, and any number of functions may occur responsive to detection of an anomaly. For example, additionally or alternatively to the anomaly function depicted in data flow 400, the buffered data may be written to persistent memory and stored for forensic analysis. In such a scenario, responsive to detecting an anomaly, the netcam may transmit an alert to an administrator and/or may generate an event log indicative of the anomaly. Any other aforementioned anomaly function is equally applicable. As an example of forensic analysis, a known type of attack on a system such as a data center is a timing attack. Timing attacks may have “signatures,” in that an inter-packet spacing of traffic can be learned (e.g., by training a machine learning model using timing patterns as labeled by whether the timing pattern was a timing attack, by using pattern recognition, etc.). Forensic analysis may be performed to determine whether the data was a timing attack. Timing attacks may be blocked (e.g., by dropping data packets from a buffer upon netcam module 113 determining that the buffered data represents a timing attack).

As mentioned above, buffered data may include byte stamps (as opposed to, or in addition to, buffered packets). Byte stamps may be used in analyzing an anomaly (e.g., in forensic analysis, network debugging, security analysis, etc.). An advantage of using byte stamps, rather than buffered data packets, is that storage space is saved, and byte stamps are computationally less expensive to process. Byte stamps for an amount of time corresponding to an anomaly may be analyzed to determine a cause of the anomaly. The trade off in using byte stamps, rather than buffered packets, is that buffered packet data is more robust and may provide further insights into an anomaly.

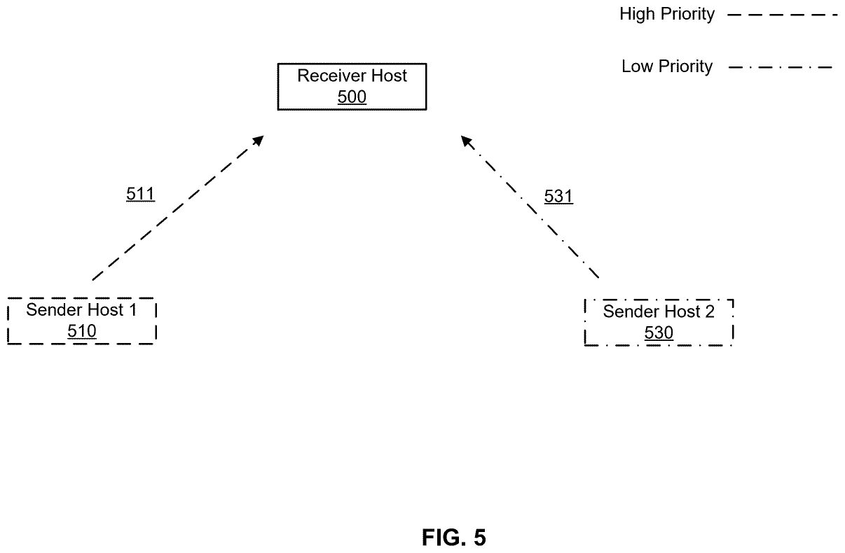

FIG. 5 is a network traffic diagram showing a receiver host receiving both high and low priority traffic from sender hosts, according to an embodiment of the disclosure. As depicted in FIG. 5, sender host 510 transmits high priority data flow 511 to receiver host 500, and sender host 530 transmits low priority data flow 531 to receiver host 500. Where network congestion occurs and an anomaly is detected, the sender hosts may treat the high and low priority traffic differently. In an embodiment, sender host 530 detects network congestion sooner than sender host 510 because low priority data flow 531 is associated with a lower one-way delay threshold than high priority data flow 511. Therefore, sender host 530 may perform remedial action, such as pausing network transmissions of low priority data flow 531, for a pause time, while high priority data flow 511 continues to transmit because its higher one-way delay threshold has not yet been reached. Where high priority data flow 511 does reach its higher one-way delay threshold, and a pause action is responsively taken, that pause time may be lower than the pause time for low priority data flow 531, thus ensuring that high priority data flow 511 resumes sooner and during a time of less congestion than it would face if low priority data flow 531 were not paused for extra time while high priority data flow 511 continued.

Similarly, with respect to shadow buffer operation, a high priority shadow buffer may be separately maintained by receiver host 500 for high priority data flow 511, and a low priority shadow buffer may be separately maintained by receiver host 500 for low priority data flow 531. The drain rate may be weighted differently on the basis of priority. For example, the high priority shadow buffer may have a higher drain rate relative to a drain rate used for the low priority shadow buffer, thus resulting in the high priority shadow buffer being less likely to cause a detection of an anomaly than the low priority shadow buffer.

While depicted as two separate sender hosts, sender hosts 510 and 530 may be a same host, where one sender host transmits both high and low priority traffic to receiver host 500. Thus, a same sender host may take remedial action (e.g., pause) responsive to detecting an anomaly of low priority data flow 531 while continuing to transmit high priority data flow 511 as normal. Sender hosts may have multiple buffers 111, each buffer corresponding to a different priority of data.

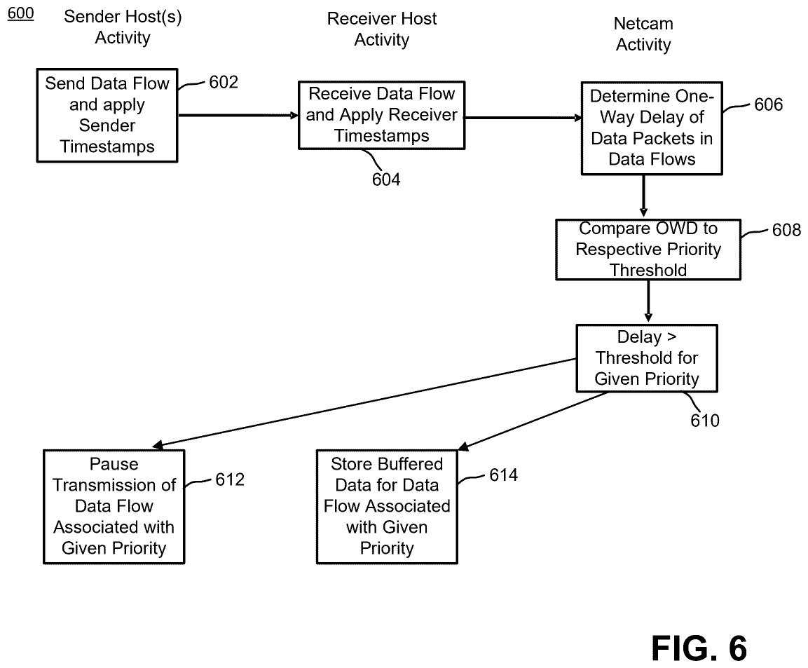

FIG. 6 is a data flow diagram showing netcam activities where priorities are accounted for in determining netcam activity, according to an embodiment of the disclosure. Data flow 600 begins with one or more sender hosts (e.g., sender host 110) sending 602 a data flow and applying sender timestamps (e.g., sender timestamp 311). A receiver host (e.g., receiver host 130) receives 604 the data flow and applies receiver timestamps (e.g., receiver timestamp 321). Netcam activity then occurs. As described above, the netcam activity may occur at the sender host(s) (e.g., by receiving ACK packets indicating receiver timestamps and using netcam modules to compute one-way delay), at receiver hosts (e.g., where sender timestamps are included in the data flow and netcam modules compute one-way delay therefrom), at netcam system 140, or some combination thereof.

The netcam determines 606 one-way delay of data packets in data flows. As explained above, the one-way delay computation may depend on a priority of the data flow, and thus different data flows may have different one-way delay thresholds (“priority thresholds”). One-way delay may be determined from packets generally, and/or may be aggregated with dwell time to form a shadow buffer one-way delay. The netcam compares 608 the determined one-way delay (or delays, in the case where shadow buffer one-way delay is used) to the respective priority threshold. Responsive to determining 610 that the one-way delay is greater than the threshold for a given priority data flow, anomaly function is initiated. As depicted in FIG. 6, some anomaly function may include one or more of pausing 612 transmission of the data flow associated with the given priority and/or storing 614 the buffered data flow associated with the given priority (e.g., for forensic analysis). As described above, the pause time may vary depending on the priority level of the paused data flow.

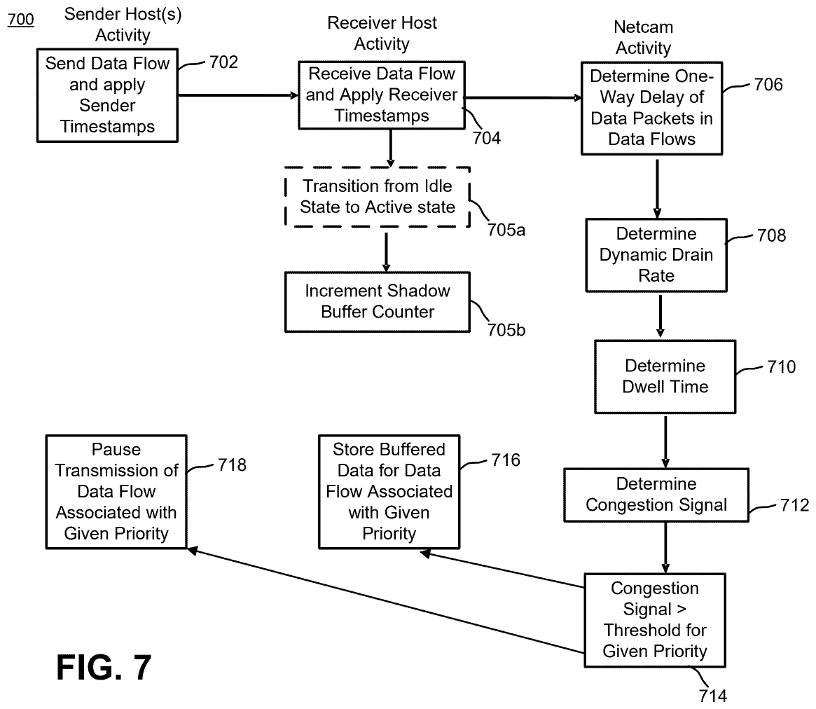

FIG. 7 is a data flow diagram showing netcam activities where shadow buffer considerations are depicted, according to an embodiment of the disclosure. Data flow 700 begins with a sender host sending 702 a data flow and applying sender timestamps, and a receiver host receiving 704 the data flow and applying receiver timestamps. These activities are performed in the manner described above with respect to elements 602 and 604 of FIG. 6. As mentioned with respect to FIG. 1, in an embodiment, the receiver host maintains both one or more regular buffers and one or more shadow buffers, where a regular buffer stores data packets as they are received, and a shadow buffer maintains a counter that ticks up as data packets are received and drains according to a dynamic drain rate (that is, decrements according to the dynamic drain rate over each unit of time). Different shadow buffers may be used for different data flows on a same receiver host, and the different data flows may have different priorities.

A shadow buffer may be in an idle state or an active state. Netcam module 133 of receiver host 130 may determine a shadow buffer to be in an active state responsive to receiving traffic of a data flow (that is, a shadow buffer for that data flow transitions from an idle state to an active state). Netcam module 133 may determine a shadow buffer to be in an idle state responsive to determining that the traffic is no longer received. For example, traffic may be deemed to be no longer received for a data flow where at least a threshold amount of time has passed since a last packet of the data flow was received. As another example, where traffic is consistently received for a data flow on a packet-by-packet basis over each unit of time, and a unit of time passes where a packet is not received for the data flow, netcam module 133 may determine that the traffic is no longer received. Thus, netcam module 133 may continue toggling a state of a shadow buffer for a data flow from idle to active and back depending on whether traffic is received for a data flow. As will be described further below, the state of the shadow buffer is used by netcam module 133 to determine other attributes relating to the shadow buffer, such as drain rate.

Assuming that the shadow buffer was idle, responsive to receiving a first packet of the data flow in 704, netcam module 133 transitions 705a the shadow buffer from an idle state to an active state, and increments 705b a counter of the shadow buffer that indicates a unit of data traffic received. Where the shadow buffer is already in an active state, 705a is not performed, but 705b continues as each unit of traffic (e.g., packet) is received. In an embodiment, netcam module 133 increments the counter by multiplying the unit of data traffic received by a factor. For example, for every packet received, the counter may be incremented by multiplying the unit by a number greater than 1 (e.g., 1.01, or 1.1). As a particular example where there are multiple priorities, if a packet is received, the shadow buffer may be multiplied by 1.01 if it is a high priority flow, or by 1.1 if it is a low priority flow. The higher the factor, the more quickly the shadow buffer counter will have a number that exceeds a threshold reflecting an anomaly (e.g., a scenario that merits pausing traffic and/or performing remedial measures).

The netcam (that is, either netcam system 140 or netcam module 133, or some distributed processing) performs the netcam activity depicted in the right-most column of FIG. 7. For convenience, the activity will be referenced as performed netcam module 133, but distributed or entire processing by netcam system 140 is equally possible.

Netcam module 133 determines 706 a one-way delay of data packets for each data flow, and determines 708 a dynamic drain rate for each shadow buffer corresponding to each respective data flow. While 706 and 708 are depicted sequentially in FIG. 7, these may be performed in parallel with one another or in an opposite order from what is depicted. Element 706 may occur at any point between where it is depicted in FIG. 7 up until the occurrence of 714. Element 706 may be performed in the same manner described above with respect to 606 of FIG. 6.

Netcam module 133 may determine the dynamic drain dynamic drain rate based on a number of units of the data removed from the regular buffer per unit of time while the shadow buffer is in the active state. That is, if three bytes are removed from the regular buffer for transmission to a next node in a data flow per microsecond, then the rate of 3 per microsecond is a basis from which the dynamic drain rate is determined, multiplied by a factor less than 1 (e.g., 0.9 or 0.95) such that drain from the shadow buffer occurs more slowly than drain from the regular buffer. The reason to decrement the shadow buffer at a slower rate than the regular buffer is, again, to ensure that where an anomaly might occur on the regular buffer, it is first detected using the shadow buffer. Netcam module 133 may select a factor to multiply by the drain rate based on priority of data flow, where high priority data flows have higher drain rates (e.g., 0.95-0.99), where medium and low priority data flows have lower drain rates (e.g., 0.9-0.94 for medium and 0.85-0.89 for low).

Netcam module 133 may determine the dynamic drain rate on any cadence, such as each time a data packet is received by receiver host 130, or on a slower cadence, such as for every Nth data packet received in a given data flow. Netcam module 133 may limit performance of determining 708 the dynamic drain rate to scenarios where the shadow buffer is in an active state. Where the shadow buffer is in an idle state, netcam module 133 may render a last determined dynamic drain rate as a static drain rate to use over time to decrement the shadow buffer until such a time that the shadow buffer re-enters an active state, whereafter netcam module 133 may recalculate a new dynamic drain rate.

The dynamic drain rate is used by netcam module 133 for two purposes. First, the dynamic drain rate is used to decrement the shadow buffer counter over time. Second, the dynamic drain rate is used to calculate a “dwell time.” The term dwell time, as used herein, refers to a value that may be aggregated with the actual one-way delay of packets on a data flow as a congestion signal for determining whether there is an anomaly in the data flow that requires remedial measures to be taken.

Netcam module 133 determines 710 the dwell time as a function of the counter of the shadow buffer (e.g., which is a proxy of a length of the regular buffer with some added length based on the incremental and drain multiplier factors) and the dynamic drain rate. In an embodiment, netcam module 133 calculates the dwell time by dividing a value of the counter of the shadow buffer by the dynamic drain rate.

Netcam module 133 determines 712 a congestion signal for the data flow based on the dwell time. In an embodiment, netcam module 133 determines the congestion signal by mathematically aggregating a one way delay between the sender host and the receiver host with the dwell time. Similar to calculating the dynamic drain rate and incrementing the counter, netcam module 133 may weight the dwell time by a factor. For example, the dwell time may be weighted depending on priority of a data flow, where a larger multiplier may be used for lower priority data flows, and a smaller multiplier may be used for higher priority data flows (e.g., 1.01-1.05 for a high priority data flow; 1.06-1.14 for a medium priority data flow; 1.15-1.30 for a low priority data flow). This, again, will cause higher priority data flows to be impacted less frequently than lower priority data flows that will more quickly have their congestion signal reach a threshold that triggers remedial action.

In a similar manner to FIG. 6's discussion of elements 610-614, netcam module 133 may determine 714 that the congestion signal exceeds a threshold (e.g., a priority-specific threshold, similar to that used for regular buffers), and may take remedial action. The remedial action may include storing 716 data or indications of data for the associated data flow, and/or pausing 718 transmission of the associated data flow.

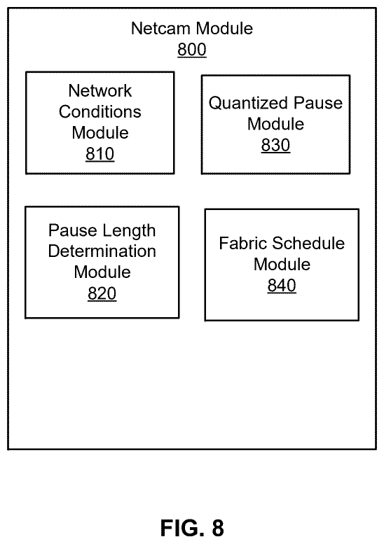

FIG. 8 illustrates exemplary sub-modules of a netcam module for use in a long-link environment, in accordance with an embodiment of the disclosure. As depicted in FIG. 8, netcam module 800 includes network conditions module 810, pause length determination module 820, quantized pause module 830, and fabric schedule module 840. Netcam module 800 may be any netcam module, such as netcam module 113, netcam module 133, and/or a netcam module implemented by netcam system 140. Processing described as performed by netcam module 800 may be distributed among any number of netcam modules and netcam system 140 as depicted in FIG. 1.

Network conditions module 810 determines a set of conditions of the network between a sender host and a receiver host. The determination of network conditions is discussed at length in the foregoing (e.g., determining congestion on a path and/or for a data flow, bandwidth conditions, jitter, and so on; network conditions may also include a priority of a data flow transmitted through a network). As discussed in the foregoing, a shadow buffer may inform network conditions (e.g., by alerting to imminent congestion), and network conditions module 810 may determine conditions based on this information informed from the shadow buffer.

Beyond determining congestion and the like, network conditions module 810 may determine whether or not the link is a long link, as this may drive a decision by netcam module 800 as to whether or not to deploy quantized pausing. To this end, network conditions module 810 may determine a one-way delay of data traffic between the sender host and the receiver host (e.g., as described with respect to at least FIGS. 3 and 5). Network conditions module 810 may determine whether the one-way delay exceeds a threshold one-way delay, and responsive to determining that the one-way delay exceeds the threshold one-way delay, network conditions module 810 may determine that the link is a long link (e.g., which may cause netcam module 800 to apply a series of quantized pauses rather than one discrete pause, as discussed below). Responsive to determining that the one-way delay does not exceed the threshold one-way delay, network conditions module 810 may determine that the link is not a long link, and netcam module 800 may therefore refrain from using quantized pauses. That is, netcam module 800 may apply a length of pause is completely responsive to determining that the one-way delay does not exceed the threshold one-way delay.

Following a determination of the set of conditions, pause length determination module 820 may determine a length of pause to apply to the traffic. Pause length may be determined by pause length determination module 820 in any manner disclosed in the foregoing, such as being predefined by a user, defined based on data type, defined based on a priority of a data flow corresponding to the set of conditions of the network, and so on.

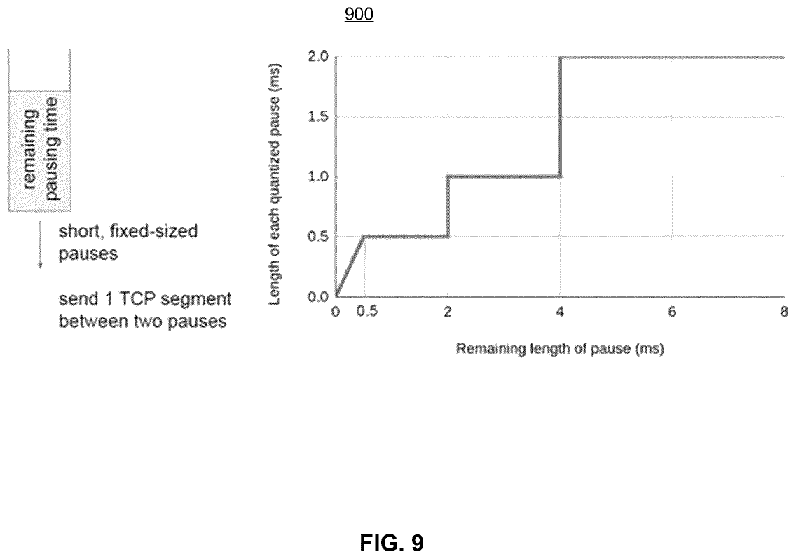

Quantized Pause Module 830 transmits the traffic using a series of quantized pauses. A unit of traffic may be transmitted between each quantized pause. Turning briefly to FIG. 9 to illustrate the quantized pause concept, FIG. 9 illustrates a graphical depiction of an application for applying quantized pauses, in accordance with an embodiment of the disclosure. As depicted in graph 900, pause length determination module 820 may determine if a length of pause is over 4 milliseconds, and may responsively determine that a next pause of the series of pauses for the length of pause will be for two milliseconds. Where the remaining length of pause is between 2 and 4 milliseconds, then a next pause of the series of pauses will be for 1 millisecond. Where the remaining length of pause is between 1 millisecond and 2 milliseconds, the next pause is to be for half a milliseconds. Where the remaining length of pause is a half millisecond or less, then the remainder of the length of pause is applied.

Graph 900 is merely exemplary, and any function may be applied that dictates how long a next segment of a length of pause should be. That is, graph 900 represents a step function, where different lengths of quantized pause are applied depending on the remaining pause length. However, the step function is merely exemplary; any function for determining a quantized pause length may be used, such as a linear function, an exponential function, a logarithmic function, a quadratic function, a decay function, and so on.

As depicted in graph 900, one TCP segment is sent between two quantized pauses. This is merely exemplary, and any unit of any type of traffic (whether TCP or otherwise, such as UDP) may be defined to be sent between quantized pauses. One unit of traffic may be defined to be any amount of traffic that is to be sent between quantized pauses. For example, one unit of traffic may be one data packet, ten data packets, or any number of data packets (or other forms of communication).

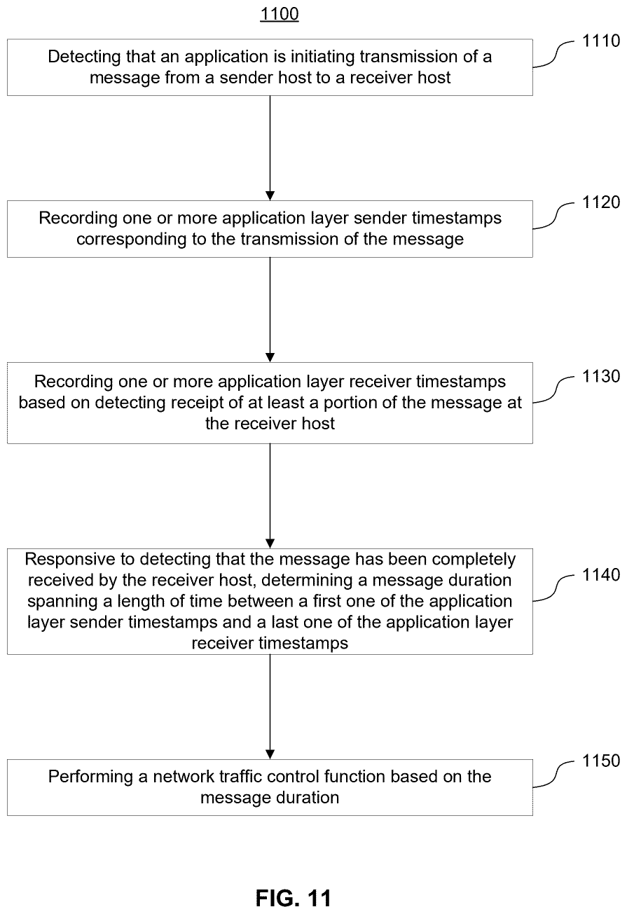

Applying these quantized pauses results in many benefits. As one benefit, network control functions will have reduced sensitivity on minimal one-way delay (OWD). For example, to achieve good control, for network controllers operating with the schema described with respect to FIGS. 1-10, OWD threshold needs to be higher than and close to the minimum OWD. However, in long-distance links, the min OWD may fluctuate due to wavelength changes (e.g., triggered by Multiprotocol Label Switching (MPLS)) in optical fibers. In scenarios where the minimum OWD becomes higher than the OWD threshold, network controllers (e.g., described with respect to FIGS. 1-10) may over-pause and cause throughput loss. Thus, monitoring for and transitioning from those embodiments to those of FIGS. 11-13 where long-range links are used results in more efficient bandwidth usage

Moreover, quantized pausing makes these network controllers insensitive to the relationship between min OWD and OWD threshold. Even in scenarios where the minimum OWD is higher, network controllers will not over-pause. Yet further, traffic burstiness is reduced when unpausing. Still further, more information may be conveyed by packet traces, in that a receiving node can analyze a gap between packets to determine if those packets are delayed (the gap is different from those pre-set values) or not. If they are delayed, the receiving node may determine that current throughput equals the bottleneck bandwidth.

Returning to FIG. 8, in order to determine a quantized pause length, quantized pause module 830 compares the length of pause determined by pause length determination module 820 to a threshold. The threshold may be determined by a step function, as described above. In some embodiments, rather than using a threshold, a monotonic function or other function may be used. In the case of a step function, in response to determining that the length of pause exceeds the threshold, quantized pause module 830 may instruct the sender host to pause the traffic for a first amount of time. In response to determining that the length of pause does not exceed the threshold, quantized pause module 830 may instruct the sender host to pause the traffic for a second amount of time smaller than the first amount of time. To illustrate this, following from FIG. 9, the threshold may be 2 ms, where a quantized pause of 1 ms is selected if the pause length exceeds 2 ms, and where a quantized pause length of 0.5 ms is selected if the pause length does not exceed 2 ms.

In some embodiments, quantized pauses may be occurring in rapid succession, which causes a requirement that units of traffic be transmitted without delay. Moreover, because the quantized pauses are occurring on data flows that have congestion, other traffic, such as acknowledgments for receipt of a given unit of traffic, may be delayed. Thus, in some embodiments, following each given quantized pause of the series of quantized pauses, a next unit of traffic may be transmitted without reliance on receipt of an acknowledgement packet from the receiver host for a prior unit of traffic that was transmitted prior to the given pause. This ensures that each unit of traffic is timely transmitted according to the quantized pause schedule.

Quantized pause module 830 may detect a new set of conditions of the network between the sender host and the receiver host, and may apply a new series of quantized pauses to transmission of the traffic based on a new length of pause determined from the new set of conditions. In some embodiments, quantized pause module 830 may perform this detection by receiving an alert from network conditions module 810 that the conditions have changed. The alert may be unsolicited by quantized pause module 830. Alternatively, quantized pause module 830 may request an alert when conditions change, and/or may expressly request a determination of conditions at certain trigger points (e.g., periodically, after a certain number of quantized pauses occur in a series, are at any other trigger points), and may receive the results of the determination at those times. Thus, quantized pause module 830 may, before transmitting a quantized pause series for the full amount of a pause length, may cause a redetermination of the length of pause based on a redetermination of the set of conditions of the network (e.g., each time a predefined number of quantized pauses occur).

FIG. 10 illustrates a network traffic diagram showing a message rocket implementation for applying network control to application layer messages, in accordance with an embodiment. As depicted in FIG. 10, sender host 110 runs sender app 150, which communicates at the application layer using conduits 1002 (e.g., sockets, queue pairs, etc., depending on protocol). Application messages are transmitted via application channel 1004 split across the conduits to receiver app 1060 of receiver host 130 through conduits 1006. Application messages are divided into “chunks” when they are transmitted, and received as “chunks” by receiver hosts, in order to improve network throughput, each chunk transmitted by a different conduit. A message rocket module (e.g., run at any one or combination of message rocket module 114 of the sender host, message rocket module 135 of the receiver host, and clock synchronization system 141 outside of both hosts) monitors and may control application layer traffic. All principles of clock synchronization, netcam control, quantized pause, shadow buffers, and so on from FIGS. 1-9 are applicable to the sender and receiver hosts of FIG. 10. The message rocket module may be located at a central coordinator and/or may have distributed functionality across host and/or receiver modules.

When the message rocket module detects that an application is initiating transmission of a message from sender host 110 to receiver host 130, the message rocket module may record sender timestamps. These sender timestamps may be one or both of timestamps from origination at the sender app 1050 (depicted as t_{msg_Tx}) and/or from each conduit (separately recorded for each conduit on a per-chunk basis as t_{chunk_Tx}). Similarly, as timestamps are received at conduits 1006, receive timestamps for each chunk are recorded as t_{chunk_Rx}, and when all chunks are received and the message is completely received by receiver app 1060, a message received timestamp is recorded as t_{msg_Rx}. The message rocket module may calculate message durations, including a chunk duration and a complete message duration. The chunk duration would, for a given chunk, be calculated as t_{chunk_Rx}−t_{chunk_Tx}. The complete message duration would, for a completed message, be calculated as t_{msg_Rx}−t_{msg_Tx}. Either or both of the chunk and complete message duration may be used to perform application layer control. The term “message duration” may refer to either or both of chunk durations and complete message durations.

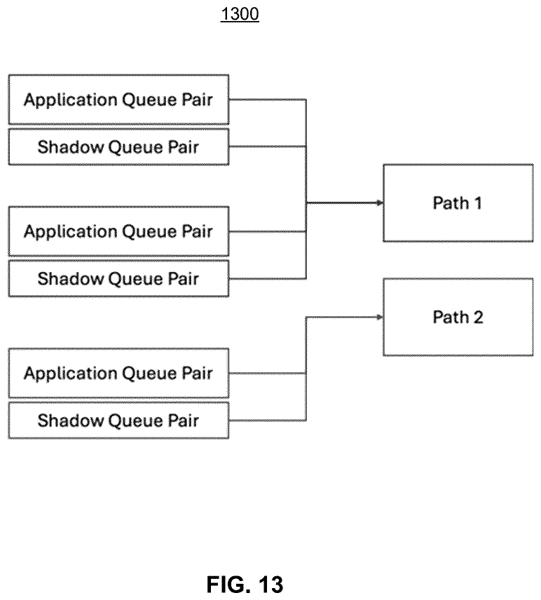

In some embodiments, rather than using delays measured with timestamps on transmission and reception of messages and/or chunks, delays may be measured using “shadow probes” across shadow queue pairs that are not the messages or chunks themselves. In some embodiments, the message rocket module may form shadow queue pairs (QPs). While QPs form traditional application layer connections (e.g., TCP connections), shadow QPs form similar pairs but for RDMA networks, and are a manner in which two NICs can communicate using low-overhead that is guaranteed to follow the same path as its corresponding QP. As will be discussed in further detail below with respect to FIG. 13, FIG. 13 shows exemplary shadow queue pairs instructed to follow paths of their corresponding application queue pairs. Illustration 1300 shows that if there are 3 application QPs, and each is assigned a shadow QP, the first two application QPs take path 1. Their corresponding shadow QPs are instructed to ensure that they are forced to communicate down the same path. Shadow QPs can provide real-time measurements of OWD and ECN (Explicit Congestion Notification) in order to inform path quality. In some embodiments, the implementation of Shadow QPs relies on the use of UD (Unreliable Datagram) Queue Pairs, which expose the IP header of the packet on the receiver side. Parsing this header provides ECN bits. Furthermore, use of NIC hardware timestamps provides accurate OWD measurements.

The message rocket module performs one or more network traffic control functions based on the message duration. These functions are similar in principle and operation to those performed by the netcam module. That is, message duration is similar to one-way delay measurements used to determine whether netcam operations should occur with reference to a threshold, as described in the foregoing. A threshold may be determined (e.g., predetermined, dynamically, or in any other manner described with respect to netcam pausing). Message duration (e.g., as computed using timestamps or shadow queue pair measurements) may be compared to the threshold, and where message duration is higher than the threshold, the message rocket module may pause transmission of the message. This may be performed with respect to chunks (where it is chunk duration that is compared to the threshold), or with respect to the complete message.

The threshold may be a constant configured by an operator of the system, or may be learned. An example learning algorithm may include, determining the minimum or a percentile (e.g., 5% percentile) of chunk duration in a prior time range (e.g., in the prior second plus a fixed offset), and using that determined value as the threshold for the next time range. Where messages are paused, the pause length may be determined in any manner disclosed above. Quantized pause may be applied by the message rocket module, in order to determine the duration of pauses. Where pausing is applied with respect to chunks, the pausing is applied to the individual conduit (e.g., socket, queue pair, etc.) that is experiencing a high duration.

All foregoing disclosures with respect to shadow buffer and netcam functions apply equally to message rocket module functionality at the application layer, by replacing packet one-way delay where described with respect to shadow buffer and netcam above with message duration (e.g., chunk duration and/or complete message duration) for application layer messaging. That is, any netcam function, whether or not using shadow buffers, can be performed by the message rocket module with respect to application messages. This includes pausing, applying jitter, re-transmitting, using quantized pause, performing differentiated activity for different priority messages, and so on.

As a more particular example for using shadow buffers for application layer messages, a shadow buffer may be deployed as normal at a receiver application. One shadow buffer may be deployed per sender app to receiver app connection (though, at a given receiver, the shadow buffers of several connections may be consolidated into a single data structure). The shadow buffer is a counter that acts to dynamically measure the utilization of the link on the connection that it is monitoring. Again, like normal shadow buffer activity, the shadow buffer may be in an active phase (while receiving traffic) or in an idle phase (while not receiving traffic). When in the active phase, for every X bytes received on the connection, the shadow buffer increments its counter by X bytes. The shadow buffer is decremented by an amount close to, but less than 1 (e.g., based on priority of connection, or any other factor described in the foregoing with respect to decrementing). The shadow buffer calculates a dynamic drain rate based on the number of bytes removed per unit time in the active phase. Drain weight may vary depending on priority of a conduit or application message, where higher priority applications have higher drain rates. When idle, the shadow buffer decrements bytes at the most recent drain rate that was calculated when last active.

As with netcam messages, dwell time is calculated as a function of shadow buffer length and current drain rate (e.g., length divided by current drain rate, or any other manner discussed with respect to shadow buffers in the foregoing). The message rocket module then may, where determining congestion for given chunks, use chunk_duration_{SB}=chunk_duration_{actual}+SB_dwell_time as a congestion signal, rather than just the chunk duration of the measured path (where “SB” stands for shadow buffer). Similarly, SB_dwell_time for a complete message plus its actual duration may be used as a congestion signal for a complete message. This provides an early warning of congestion on a chunk-by-chunk basis or message-by-message basis. This means that when determining whether to take any network control activity (e.g., netcam activity, message rocket activity, etc.) for an application layer message based on a delay threshold (e.g., threshold chunk delay), the SB_dwell_time plus the actual duration (chunk or message) may be compared to the threshold, rather than the actual duration alone.

Whether or not the shadow buffer is used to compare delay (e.g., for a chunk) to a threshold in order to determine whether a network control activity should occur, when that activity is determined to go forward and include a pause, the pause would be applied for chunks transmitted by a conduit (e.g., socket, queue pair, etc.) having a delay exceeding the threshold. The length of pause may be determined in any manner discussed in the foregoing (e.g., quantized pause, applying a pause length to be a length of the delay (e.g., for the given chunk) minus the threshold, etc.

The message rocket module may, when monitoring for congestion across various conduits 1004, redirect traffic from sender app 1050 to receiver app 1060 for a given flow to different conduits. The message rocket module may dynamically determine where to redirect traffic based on network control flow functions and buffer and/or shadow buffer length, redirecting traffic from congested conduits to less congested conduits.

FIG. 11 illustrates an exemplary flowchart for applying network control to application layer messages, in accordance with an embodiment. Process 1100 is executed by one or more processors executing non-transitory instructions to perform operations described with respect to the message rocket module (e.g., message rocket module 114, message rocket module 135, a message rocket module as part of clock synchronization system 141, or at any other central location). Process 1100 begins with the message rocket module detecting 1110 that an application is initiating transmission of a message from a sender host to a receiver host. The message rocket module records 1120 one or more application layer sender timestamps corresponding to the transmission of the message and records 1130 one or more application layer receiver timestamps based on detecting receipt of at least a portion of the message at the receiver host.

Responsive to detecting that the message has been completely received by the receiver host, the message rocket module determines a message duration spanning a length of time between a first one of the application layer sender timestamps and a last one of the application layer receiver timestamps (e.g., possibly including a shadow buffer duration). The message rocket module performs a network traffic control function based on the message duration (e.g., any control function described herein with respect to the netcam module, the shadow buffer, quantized pause, or any other portion of the disclosure).

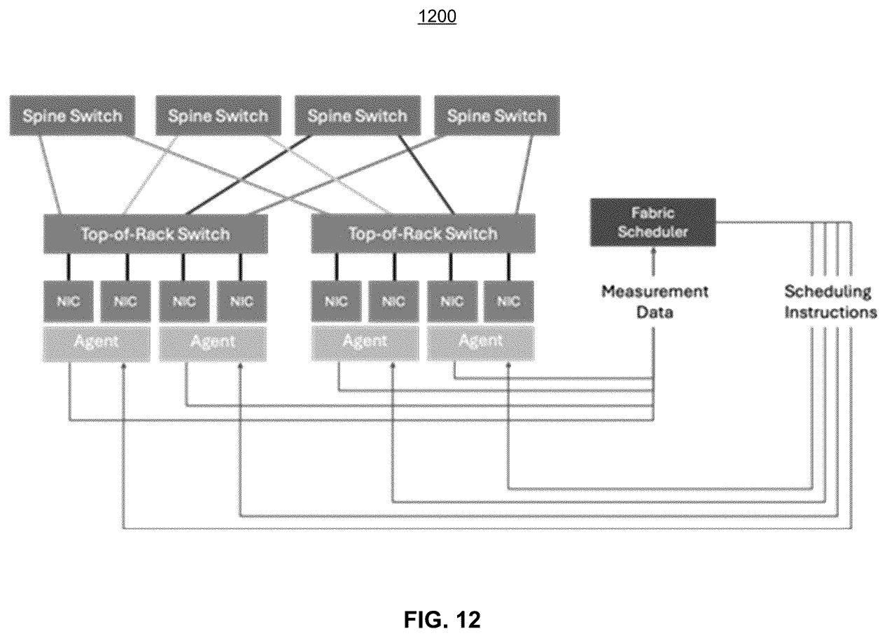

FIG. 12 is a network diagram for an exemplary multi-stage interconnection network, in accordance with an embodiment. As depicted in FIG. 13, interconnection network 1300 includes a fabric scheduler, agents with corresponding NICs, and paths through various network components including a top-of-rack switch and a spine switch, though any other switches, gateways, and other network components not depicted may be present. The fabric scheduler may perform any network coordination activity or coordinated control activity, as described with respect to netcam system 140 and/or netcam modules 113 and 133. While depicted as a centralized entity, the fabric scheduler may be present on one or more individual agents, as described with respect to netcam module 113 and netcam module 133. The agents may be sender hosts (e.g., sender host 110) and/or receiver hosts (e.g., receiver host 130). The NICs may be part of their respective hosts (e.g., NIC 112 and NIC 132). The switches may be part of, e.g., network 120.

Fabric schedule module 840 may, in the context of interconnection network 1200, coordinate scheduling of data flows through interconnection network 1200. To perform this scheduling, fabric schedule module 840 may detect paths used by the application through the network and detect other link quality metrics using a probe mesh. Fabric schedule module 840 may determine link utilization for each path, and may coordinate traffic scheduling based on the utilization. Fabric schedule module 840 implements an edge-based method that does not require collection of measurements by the switches of interconnection network 1200.

In order to detect paths and link quality metrics used by an application layer, Fabric schedule module 840 may leverage rules of application layer network transmissions. For example, in routing strategies such as ECMP (Equal-cost multi-path routing), the route taken by traffic is determined by a hash on the 4-tuple defining the connection parameters: (Source IP, Source Port, Destination IP, Destination Port). For such routing strategies, fabric schedule module 840 may (1) determine per-link bandwidths and (2) use that information to schedule traffic. Fabric schedule module 840 may, for each respective flow over a network initiated by an application layer, determine a routing strategy.

Fabric schedule module 840 may detect paths and link quality through a probe mesh. The term probe, as used herein, may refer to a packet used to determine OWD on a link. The term probe mesh refers to the aggregate information observed by transmitting probes through the network. The fabric schedule module 840 creates the probe mesh by sending small packets via standard Unix sockets, IB verbs, or any other end-to-end communication library. This probe mesh will work on any kind of network: for example, InfiniBand networks, RoCE networks, TCP/IP over Ethernet networks, or any other kind of network. The probe mesh sweeps 4-tuples and determines (1) the space of possible paths in the network that connect edge NICs (e.g., as depicted in FIG. 13), and (2) one-way delays and ECN (Explicit Congestion Notification) counts on those paths. Fabric schedule module 840 may calculate one-way delay across a path in any manner discussed in the foregoing. Common route-detection tools (e.g. traceroute) can provide the exact path that the probes on each connection take. Link quality may be determined based on OWD and ECNs, among other characteristics.

Following determining all paths used by the application layer, fabric schedule module 840 determines utilization for each path. In an embodiment, Fabric schedule module 840 performs a direct measurement of link utilization. In such an embodiment, a data path sensor reports the throughput of individual end-to-end connections. This sensor can be a custom NCCL plugin or any other middleware that sits in between the application and the data path (e.g. IB/RoCE) library calls. Since the 4-tuple of each connection is known, the path of each of these connections is provided through traceroute. Fabric schedule module 840 may determine the utilization based on a comparison of the throughput relative to the bandwidth capacity of the path.

In an embodiment, fabric schedule module 840 may determine the utilization by way of performing an estimation from probes, where the probe mesh is used to estimate the link utilizations. In cases where a switch simultaneously serves multiple flows, fabric schedule module 840 may determine the link utilization (or an estimation thereof) by the probability that a given probe encounters queueing. On a particular path x, let Pₓ be the probability of a probe encountering queuing at one or more switches and let Pᵢ be the probability that a probe encounters queueing at switch i. Then,

$${P}_{x} = 1 - {\prod }_{i = 1}^{n} [ i ϵ x ] ( 1 - {P}_{i} ) .$$

For all paths x, transforming the above into log space can provide a system of linear equations. Solving this system of linear equations yields the estimated utilization at each switch,

$$log ( 1 - {P}_{x} ) = {\sum }_{i = 1}^{n} [ i ϵ x ] log ( 1 - {P}_{i} ) .$$

In order to determine scheduling, fabric schedule module 840 determines an optimal usage across each path. The manner of determining optimal usage depends on whether the coordinator operates as a central fabric scheduler, or whether agents make local scheduling decisions using only data that they have. Hybrid approaches are possible, where cliques of agents exchange information and make semi-local scheduling decisions. For example, a hybrid approach may include a group of central fabric schedulers, each of which applies to a particular subset of nodes on the network. The group of central fabric schedulers may be hierarchical to accommodate scales at which it is impractical for a single fabric scheduler cannot communicate with all nodes (e.g. “ground-level” fabric schedulers provide instructions directly to end hosts, while “top-level” schedulers can provide information to the ground-level schedulers).

In scenarios where there is a central fabric scheduler, a central fabric scheduler receives the above real-time measurement data from a set of agents. Fabric schedule module 840 performs the necessary computations to determine link-level bandwidths and bandwidth-maximizing routes for any given source or sink. Consider a topology of N nodes {1, . . . , n}. These nodes can be NICs or switches. The data path sensor and probe mesh will provide:
A set of matrices {P₁, . . . . Pₖ}, where Pᵢ∈{0,1}^{n×n}, each of which describes a path between two NICs. In each of these matrices, 1 encodes the presence of an edge, while 0 encodes the absence of an edge. Every path will involve exactly two NICs and some number of switches.
A set of utilizations {U₁, . . . , Uₖ}, where Uᵢ∈ [symbol] , which is in Gbps.

The agents of interconnection network 1200 will compute U and P and send this data to the coordinator. Then, the usage of each link in the network is given by a matrix W∈ [symbol] ^{n×n} which can be computed by the coordinator:

$$W = {\sum }_{i ϵ \{ 1 , … , k \}} {U}_{i} {P}_{i}$$

If B is the matrix of available bandwidth on each link, then the available capacity on each link is defined by C=B−W. Then, given source NIC i and a destination NIC j, the optimal allocation of routes can be computed by applying a max-flow algorithm on inputs (C,i,j). After the optimal path is computed, it is sent back to the agents for use.

Where local scheduling is performed by one or more agents, the local scheduling can occur in two phases: Byte-Balance and Route-Scout.

Where a Byte Balance approach is used, at any given moment, the agent maintains several queue pairs (QPs). Queue Pairs describe two queues, including a send queue and a receive queue, where the send queue handles outgoing data and commands, and the receive queue manages incoming data. Work requests are submitted to the queue pairs to perform individual DMA operations. This is analogous, in a DMA environment, to pairs of NICs that form paths where the agents corresponding to the NICs of the pair are sender and corresponding receiver hosts for a given data flow. The fabric scheduler evaluates each QP according to metrics. Example metrics may include a number of packets with an ECN mark signaling that congestion has been encounter, one-way delay measurements using NIC timestamps to cut out stack latency, and any other metrics as compared to, e.g., a rubric for performance relative to each metric. The metrics may, in some embodiments, be provided by the Shadow Queue pair that takes the same route as the original (described in further detail below with reference to FIG. 13).

Fabric schedule module 840 determines a weight associated with the QP based on the evaluation. Then, traffic is sent on this QP in proportion to the weight that it has. The traffic balance between the QPs is iteratively adjusted until an equilibrium is reached. Where a Route Scout approach is used, when the equilibrium weights in byte balance produce a combination that is still not optimal (e.g. some signal such as delays or ECNs indicates that further improvement is possible), the coordinator creates a new QP (that has a different route though the network). If the newly created QP is better than the worst of the existing QPs (e.g., in terms of ECN/OWD metrics), the coordinator shifts traffic onto the new one, discarding the worst one. To determine whether the combination is optimal, in steady state, the proportion of ECN-marked packets equalize (e.g., with some threshold tolerance for variation) between the paths. If not, there is further balancing to be done because some paths are still better than others. Once in a balanced state, if the number of ECNs is still non-zero, the coordinator scouts for new routes to achieve further improvement (e.g., using Route Scout). If all ECNs are zero, no further improvement is possible.

Following determining optimal paths having optimal queue pairs, fabric scheduler schedule module 840 coordinates a transmission of data for each respective flow based on the optimal usage. In some embodiments, a network may be oversubscribed (for example, there exists more capacity in the spines than the NICs can produce, even if each is sending at 100% utilization). In such cases, fabric schedule module 840 can provide recovery from failed links, so that each NIC can still send at 100% even if some network internals have failed. For example, where the coordinator detects an internal link between switches is down based on no probes succeeding, the probe mesh may give all routes that use this link a capacity of 0, resulting in the flow scheduler adjusting to route all traffic away from the broken link. The fabric scheduler may additionally or alternatively perform spatial speedup to achieve higher throughput (e.g., by moving traffic away from links where throughput is approaching or exceeding 100% utilization).

In some embodiments, the fabric scheduler may form shadow queue pairs. While QPs form traditional application layer connections (e.g., TCP connections, shadow QPs form similar pairs but for RDMA networks, and are a manner in which two NICs can communicate using low-overhead that is guaranteed to follow the same path as its corresponding QP. Turning to FIG. 13, FIG. 13 shows exemplary shadow queue pairs instructed to follow paths of their corresponding application queue pairs. Illustration 1300 shows that if there are 3 application QPs, and each is assigned a shadow QP, the first two application QPs take path 1. Their corresponding shadow QPs are instructed to ensure that they are forced to communicate down the same path. Shadow QPs can, with lower overhead than QPs, provide metric information used in byte balancing and route scout approaches. For example, shadow QPs can provide real-time measurements of OWD and ECN in order to inform path quality. In some embodiments, the implementation of Shadow QPs relies on the use of UD (Unreliable Datagram) Queue Pairs, which expose the IP header of the packet on the receiver side. Parsing this header provides the ECN bits. Furthermore, use of NIC hardware timestamps provides accurate OWD measurements.

Another source of information for scheduling and routing is the detection of ECN bits through sniffing data packets. We use Open vSwitch NIC offload to configure OpenFlow policies at the end host, so that the end host can selectively mirror the ECN marked packets to a VF (virtual function) port. The fabric scheduler may deploy an ECN scraper that iterates through each VF interface, so that the fabric scheduler can then calculate the ECN stats corresponding to each interface. Specifically, the fabric scheduler is enabled to keep track of the number of packets marked with the CE (Congestion Encountered) signal per source port (e.g., for byte balancing and route scouting as mentioned in the foregoing.

Using the fabric scheduler in LLM environments leads to advantages because LLM buffers are expensive and shallow, causing differences between congested traffic and uncongested traffic to be difficult to detect. Because there is almost no buffering in LLM environments, without a central or hybrid central fabric scheduler, it is not possible to know what paths have congestion. However, with the fabric scheduler, it is possible to know utilization of data links, thereby enabling different scheduling decisions to be made on the basis of utilization. Moreover, in typical LLM environments, redundancies are typically in place, such as having an additional spine switch in case one spine switch fails. These redundancies can be used by the fabric scheduler to perform spatial speed-up, where traffic destined for congested links can be redirected to decongested or unused links.

### ADDITIONAL CONFIGURATION CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for flow scheduling through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
for each respective flow over a network initiated by an application layer:
determining a respective path taken by the respective flow from respective source host to respective destination host;
transmitting respective probe packets along the respective path while taking timestamps at the respective source host and the respective destination host; and
determining a respective one-way delay for the respective path based on the timestamps;
determining utilization for each path;
determining an optimal usage across each path; and
scheduling transmission of data for each respective flow based on the optimal usage.

2. The method of claim 1, wherein the respective path is determined based on a hash of a 4-tuple defining connection parameters between the respective source host and the respective destination host.

3. The method of claim 2, wherein the 4-tuple comprises source Internet Protocol (IP) address, source port, destination IP address, and destination port.

4. The method of claim 1, wherein the respective probe packets collect explicit congestion notification counts along the respective path.

5. The method of claim 1, wherein determining the utilization for each path comprises:
accessing, for each path, a sensor detecting throughput for the respective path; and
determining the utilization based on the throughput as compared to a bandwidth of the respective path.

6. The method of claim 1, wherein determining the utilization for each path comprises estimating the utilization based on queuing encountered by the respective probe packets.

7. The method of claim 1, wherein scheduling the transmission of data is performed by a central fabric scheduler.

8. The method of claim 7, wherein determining the optimal usage across each path comprises applying a max-flow algorithm given measure of current usage and available bandwidth on each path.

9. The method of claim 1, wherein scheduling the transmission of data is performed at least in part by a set of local agents.

10. The method of claim 9, wherein each respective source and destination form a queue pair.

11. The method of claim 10, wherein the scheduling of the transmission of data comprises:
weighting each queue pair according to a metric;
scheduling traffic for each queue pair in proportion to its weight; and
iteratively rebalancing the traffic until an equilibrium is reached.

12. The method of claim 11, wherein equilibrium is determined to be reached after a predetermined threshold is reached, and wherein the scheduling of the transmission of data further comprises:
creating a new queue pair having a different route through the network from existing queue pairs;
responsive to determining that the new queue pair has a higher weight than a worst queue pair of each of the respective queue pairs, evicting the worst queue pair and replacing it with the new queue pair; and
iteratively rebalancing the traffic until the equilibrium is reached.

13. The method of claim 10, further comprising:
creating a shadow queue pair for each different queue pair, each shadow queue pair instructed to follow a same path as its corresponding respective queue pair;
determining path quality using the shadow queue pair; and
determining traffic scheduling using the determined path quality.

14. A non-transitory computer-readable medium of one or more machines connected by a network comprising memory with instructions encoded thereon, the instructions, when executed, causing one or more processors to perform operations, the instructions comprising instructions to:
for each respective flow over a network initiated by an application layer:
determine a respective path taken by the respective flow from respective source host to respective destination host;
transmit respective probe packets along the respective path while taking timestamps at the respective source host and the respective destination host; and
determine a respective one-way delay for the respective path based on the timestamps;
determine utilization for each path; and
determine an optimal usage across each path; and
schedule transmission of data for each respective flow based on the optimal usage.

15. The non-transitory computer-readable medium of claim 14, wherein the respective path is determined based on a hash of a 4-tuple defining connection parameters between the respective source host and the respective destination host.

16. The non-transitory computer-readable medium of claim 15, wherein the 4-tuple comprises source Internet Protocol (IP) address, source port, destination IP address, and destination port.

17. The non-transitory computer-readable medium of claim 14, wherein the respective probe packets collect explicit congestion notification counts along the respective path.

18. The non-transitory computer-readable medium of claim 14, wherein the instructions to determine the utilization for each path comprise instructions to:
access, for each path, a sensor detecting throughput for the respective path; and
determine the utilization based on the throughput as compared to a bandwidth of the respective path.

19. The non-transitory computer-readable medium of claim 14, wherein the instructions to determine the utilization for each path comprise instructions to estimate the utilization based on queuing encountered by the respective probe packets.

20. The non-transitory computer-readable medium of claim 14, wherein scheduling the transmission of data is performed by a central fabric scheduler.
